(19) United States
(12) Patent Application Publication
(10) Pub. No.: US 2009/0167794 A1
(43) Pub. Date: Jul. 2, 2009

(54) LIQUID EJECTION APPARATUS, LIQUID STORAGE AND CONTROL METHOD OF A LIQUID EJECTION APPARATUS

(75) Inventors: Satoru Hosono, Azumino-shi (JP); Akio Ito, Chino-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/334,263

(22) Filed: Dec. 12, 2008

(30) Foreign Application Priority Data
Dec. 14, 2007 (JP) 2007-322969
Nov. 21, 2008 (JP) 2008-298192

(51) Int. Cl. B41J 29/38

(52) U.S. Cl. 347/6

(57) ABSTRACT

To respond to variation of characteristics of light-curable liquid. In order to do that, ink information that is recorded in a contact ROM of an ink cartridge is read out, and adjustment is performed based on the read-out ink information.

### BACKGROUND

1. Technical Field

The present invention relates to a liquid ejection apparatus such as an ink jet recording apparatus, a liquid storage, and a control method of a liquid ejection apparatus, and more particularly, to a liquid ejection apparatus, a liquid storage, and a control method of a liquid ejection apparatus that use light-curable liquid.

2. Related Art

Liquid ejection apparatuses are apparatuses that include a liquid ejecting head and eject various types of liquid from this liquid ejecting head. As a major liquid ejection apparatus, for example, there is an image recording apparatus such as an ink jet-type recording apparatus (hereinafter, simply referred to as a printer) that includes an ink jet recording head (hereinafter, simply referred to as a record head) as a liquid ejecting head and performs recording by ejecting ink in the form of a liquid as a liquid droplet from the record head so as to land in a recording sheet as an ejection target for forming a dot. Recently, these liquid ejection apparatuses are not limited to the image recording apparatuses and are applied to various manufacturing apparatuses such as display manufacturing apparatuses.

Recently, as ink that is used in a printer as one type of the liquid ejection apparatus, ultraviolet-curable ink (UV ink: one type of light-curable liquid) has attracted attention. A difference between the ultraviolet-curable ink and conventional water-based ink is that the ultraviolet-curable ink is cured by irradiating light (ultraviolet ray) after landing in a recording medium (ejection target) such as a printing sheet. Thereby, the ultraviolet-curable ink can provide a stable printing quality regardless of physical characteristics of the recording medium such as ink permeability.

In such an ink jet printer using the ultraviolet-curable ink, an ultraviolet irradiating device (light irradiating means) that irradiates an ultraviolet ray for ink that lands in the recording medium is needed to be included on the periphery (downstream side in the transport direction of the recording medium) of the record head, which is disclosed in Japanese Unexamined Patent Application Publication No. 2006-27236.

### SUMMARY

However, the UV ink has problems that the degree of change of the viscosity according to elapse of a time is high and the viscosity is irregular for each color, compared to the water-based ink. Accordingly, when ink is ejected from a nozzle opening by using a same driving signal for each color, there may be a problem that the amount of ink varies, or the amounts of consumption of ink cartridges may be different for each ink.

In addition, it is known that cure energy, that is, the minimum ultraviolet irradiation amount (light irradiation amount) needed for cure is different for each color of ink. The reason is that a coloring material has a characteristic for absorbing an ultraviolet ray of a specific wavelength. When the cure energy is excessively low, defective cure occurs. On the other hand, when the cure energy is excessively high, durability after cure deteriorates, and an effect of shrinkage of the recording medium may occur.

The present invention is contrived in consideration of such situations. The object of the present invention is that differences of characteristics of light-curable liquids are responded by controlling pressure generating means and light irradiating means based on liquid information relating to the light-curable liquid that is collected in a liquid storage.

The present invention is proposed so as to achieve the above-described object. The present invention is characterized by a liquid ejection apparatus including: a liquid ejecting head that can eject light-curable liquid collected in a liquid storage from a nozzle opening for an ejection target by operating a pressure generating means by applying a driving signal; light irradiating means that cures the light-curable liquid by irradiating light for the light-curable liquid that lands in the ejection target; and control means that controls ejection of the liquid of the liquid ejecting head and irradiation of light of the light irradiating means. In addition, a liquid storage having memory means that records liquid information including viscosity information and light irradiation amount information of the collected light-curable liquid is installed to the liquid ejection apparatus, and the control means reads out the liquid information that is recorded in the memory means of the liquid storage and controls the pressure generating means based on the viscosity information of the read-out liquid information, and adjusts a light irradiation amount of the light irradiating means based on the light irradiation amount information of the read-out liquid information.

Under the above-described configuration, since the pressure generating means is controlled based on the viscosity information, the ejection characteristics of liquids can be uniform regardless of the viscosity of the light-curable liquid. As a result, for example, it is possible that the image quality of an image recorded in the ejection target approaches to an optimal state. In addition, since the amount of light irradiation is adjusted by the light irradiating means based on the light irradiation amount information of the read-out liquid information, the light-curable liquid that lands in the ejection target can be cured efficiently with a minimum light amount needed. As a result, it is possible to contribute to saving the power. In addition, unevenness of the degrees of cure and the like of light-curable liquids can be suppressed.

In the above-described configuration, it is preferable that the viscosity information includes a viscosity changing rate of the light-curable liquid with respect to an elapsed time after the time of manufacture, and, for a case where the current viscosity is first viscosity, the control means controls the pressure generating means such that pressure at a time of liquid ejection is higher than that of a case where the current viscosity is second viscosity that is lower than the first viscosity. In addition, in this configuration, it is preferable that the control means controls the pressure generating means such that, as the current viscosity increases, the pressure at the time of liquid ejection is increased. In addition, it is preferable that, for a case where the current viscosity is the first viscosity, the control means sets the driving voltage to be higher than that of a case where the current viscosity is the second viscosity that is lower than the first viscosity.

Under this configuration, the current viscosity is calculated based on the elapsed time after the time of manufacture and the like, and the pressure generating means is controlled in accordance with the calculated current viscosity. Accordingly, even when the viscosity increases in accordance with elapse of time, the variation (decrease) of the amount of ejected light-curable liquid is suppressed. Thus, it is possible to maintain the characteristic of ejection of the light-curable liquid to a designed characteristic.

In the above-described configuration, it is preferable that the light irradiation amount information is information on light irradiation energy that is needed for curing the light-curable liquid, and the control means adjusts the light irradiation energy of the light irradiating means based on the current viscosity and the light irradiation amount information. In addition, in this configuration, it is preferable that, for a case where the current viscosity is first viscosity, the control means controls the light irradiating means such that the light irradiation energy is lower than that of a case where the current viscosity is second viscosity that is lower than the first viscosity.

Under this configuration, since the light irradiation energy of the light irradiating means is adjusted based on the current viscosity and the light irradiation amount information, the light-curable liquid that lands in the ejection target can be cured with excellent efficiency.

In the above-described configuration, it is preferable that the liquid ejecting head is configured to be able to eject a plurality of types of light-curable liquid, the light irradiation amount information is recorded in the memory means for each type of the light-curable liquid, and the control means sets light irradiation energy of the light irradiating means to light irradiation energy corresponding to light-curable liquid that is the hardest to be cured.

In addition, in the above-described configuration, it may be configured that the light irradiating means is configured by preliminary-cure irradiation means that preliminary cures the light-curable liquid to a degree not for completely curing the light-curable liquid by irradiating light for the light-curable liquid that lands in the ejection target and main-cure irradiation means that further cures the light-curable liquid by irradiating light for the light-curable liquid that is preliminary cured by the preliminary-cure irradiation means.

In addition, in this configuration, it is preferable that the light irradiation amount information for each type of the light-curable liquid includes minimum light irradiation energy and maximum light irradiation energy that are needed for the preliminary cure, and the control means sets the light irradiation energy of the preliminary-cure irradiation means to maximum light irradiation energy of the minimum light irradiation energy that is recorded in the memory means as the light irradiation amount information.

Under this configuration, since the light irradiation energy of the preliminary-cure irradiation means is set to light irradiation energy corresponding to the light-curable liquid that is the hardest to be cured, the light-curable liquid that is the hardest to be cured can be preliminary cured more assuredly. Accordingly, spread of the light-curable liquid after landing in the ejection target can be suppressed more assuredly.

In the above-described configuration, it is preferable that the control means sets the light irradiation energy of the preliminary-cure irradiation means within a range not exceeding any of the maximum light irradiation energy that is recorded in the memory means as the light irradiation amount information.

Under this configuration, the light irradiation energy of the preliminary-cure irradiation means is set to the light irradiation energy corresponding to the light-curable liquid that is the hardest to be cured within the range not exceeding any of the maximum light irradiation energy that is recorded in the memory means as the light irradiation amount information. Accordingly, while the light-curable liquid that is the hardest to be cured is preliminary cured more assuredly, the occurrence of cracks and breaks due to unnecessarily excessive light irradiation can be prevented.

In the above-described configuration, it is preferable that the viscosity information includes oxygen inhibition information that represents the difficulty of cure of the light-curable liquid due to the influence of oxygen at a time of light irradiation, and the control means adjusts the light irradiation energy of the light irradiating means in accordance with the size of a liquid droplet and the oxygen inhibition information of the light-curable liquid ejected from the nozzle opening.

Under this configuration, it may be configured that, for a case where the oxygen inhibition is first inhibition, the control means sets the light irradiation energy for a smallest liquid droplet to be higher than that of a case where the oxygen inhibition is second inhibition that is lower than the first inhibition.

Here, depending on the composition of the light-curable liquid, the liquid-curable liquid may be easily influenced by oxygen as the size of the ink droplet decreases. Accordingly, by adjusting the light irradiation energy in accordance with the size of the liquid droplet ejected from the nozzle opening and the oxygen inhibition information, the light-curable liquid can be cured more assuredly regardless of the composition of the light-curable liquid or the size of the liquid droplet.

In the above-described configuration, it may be configured that the control means changes the size of the liquid droplet ejected from the liquid ejecting head based on the oxygen inhibition information.

In addition, the control means is configured to increase the size of the ink droplet ejected from the liquid ejecting head as the oxygen inhibition increases.

Under this configuration, the size of the ink droplet ejected from the liquid ejecting head is changed based on the oxygen inhibition information. Accordingly, in particular, the size of the ink droplet ejected from the liquid ejecting head increases as the oxygen inhibition increases, and thereby the influence of oxygen at the time of light irradiation is suppressed. As a result, the light-curable liquid can be cured more assuredly.

### BRIEF DESCRIPTION OF THE DRAWINGS

FIG. 1 is a perspective view showing the configuration of a printer.

FIG. 2 is a block diagram showing the electrical configuration of a printer.

FIG. 3 is a perspective view showing the configuration of an ink cartridge.

FIG. 4 is a waveform diagram showing the configuration of a driving signal.

FIG. 5 is a diagram showing a detailed example of ink information.

FIG. 6 is a perspective view showing the configuration of a printer according to a second embodiment.

1: printer, 2: record head, 3: ink cartridge, 6: recording medium, 12: ultraviolet irradiating device, 33: contact point terminal, 34: contact point ROM, 35: printer controller, 36: print engine, 41: control unit, 43: driving signal generating circuit

### DESCRIPTION OF PREFERRED EMBODIMENTS

Hereinafter, preferred embodiments of the present invention will be described with reference to the accompanying drawings. In the embodiments described below, there are various limitations as concrete examples appropriate to the present invention. However, the scope of the invention is not limited to such embodiments unless there is description for purposes of limiting the present invention in descriptions below. Hereinafter, as a liquid ejection apparatus according to the present invention, a liquid ink jet-type recording apparatus (hereinafter, a printer) will be described as an example.

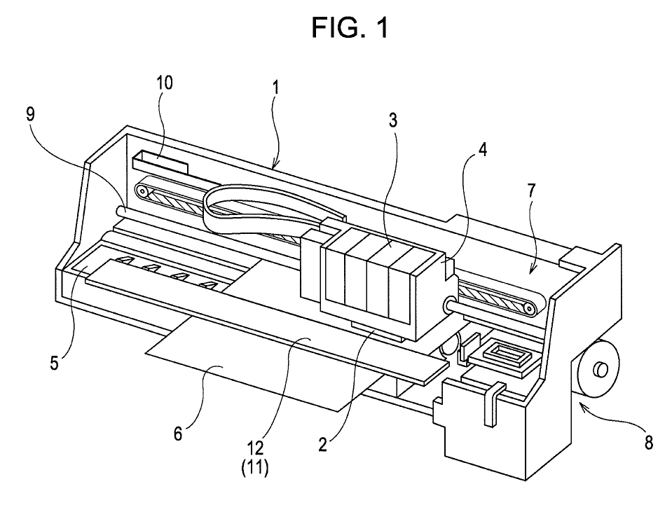

FIG. 1 is a perspective view showing the configuration of the printer 1. This printer 1 has a record head 2 as one type of a liquid ejecting head installed thereto. In addition, the printer 1 is configured mainly by a carriage 4 to which an ink cartridge 3 (one type of a liquid storage) is detachably attached, a platen 5 that is disposed on the lower side of the record head 2, a carriage moving mechanism 7 that reciprocates the carriage 4 (record head 2) in the width direction of a recording medium 6 (a recording sheet or the like) as one type of an ejection target, that is, the main scanning direction (the direction of head movement), a transport mechanism 8 that transports the recording medium 6 in the sub scanning direction that is a direction perpendicular to the main scanning direction, and an ultraviolet irradiation device 12 (corresponding to a light irradiating means according to the present invention) that irradiates an ultraviolet ray as one type of light onto a landing surface located on the recording medium 6 on which ink lands by using the record head 2. In addition, an ink composition that is stored in the ink cartridge 3 is so-called ultraviolet-curable ink (one type of light curing liquid, hereinafter abbreviated as UV ink). In this embodiment, a configuration in which the ink cartridge 3 is mounted on the carriage 4 is described as an example. However, a configuration in which the ink cartridge 3 is disposed on a casing side of the printer 1, and ink stored in the ink cartridge is supplied to the record head 2 through an ink supplying tube may be used. The ink cartridge 3 will be described later in detail.

In addition, the record head 2 according to this embodiment is configured such that four cartridges 3 that store ink (UV ink) of different colors, that is, in particular, UV ink of a total of four colors of cyan (C), magenta (M), yellow (Y), and black (Bk) can be installed thereto. Thus, nozzle rows having a total of four rows are formed in a nozzle plate in correspondence with the colors.

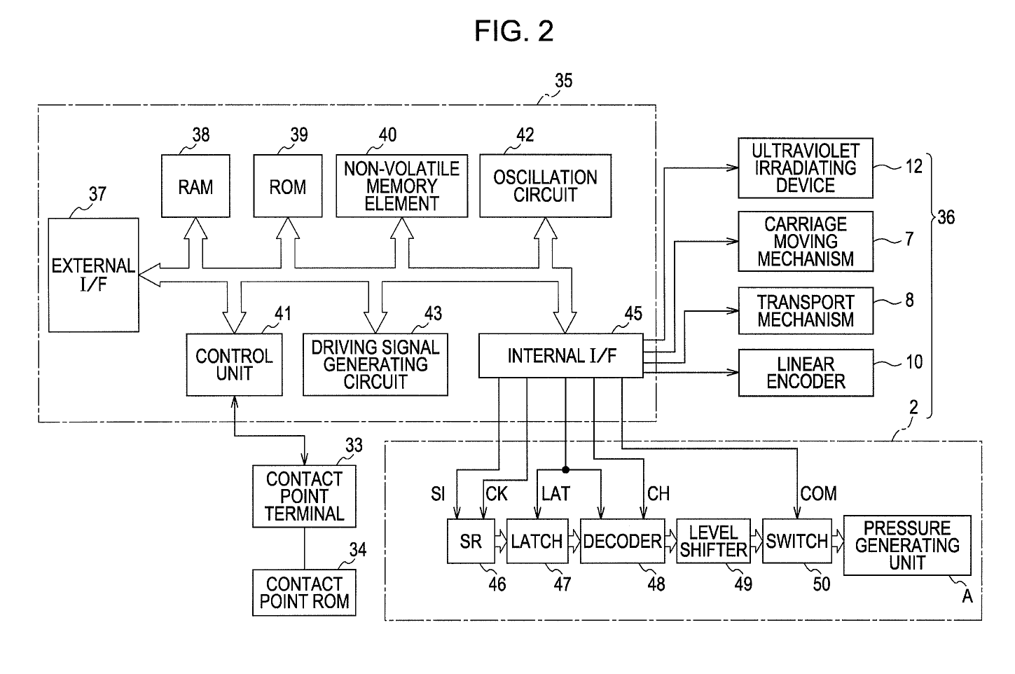

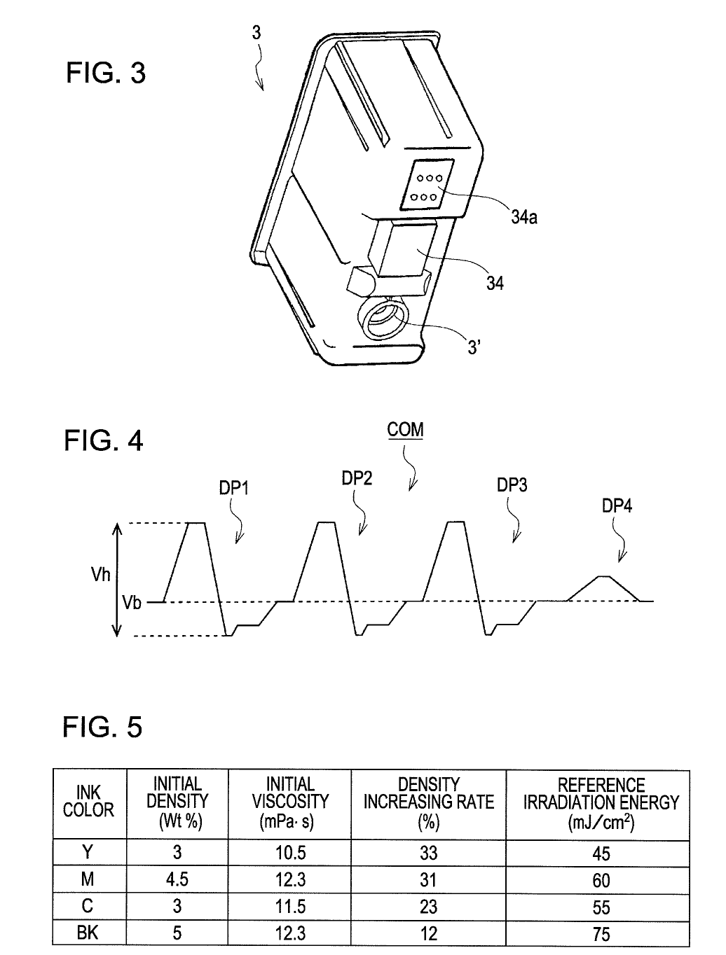

FIG. 3 is a perspective view showing the configuration of the ink cartridge 3 according to this embodiment. Any one of the ink cartridges 3 of each color has a same structure. In one end portion of the bottom face of the ink cartridge 3 in the longitudinal direction, a needle insertion part 3′ into which an introduction needle (not shown in the figure) for introducing ink into the record head 2 is disposed. In addition, to the center portion of the bottom face in the longitudinal direction, a contact ROM 34 is installed. This contact ROM 34 is one type of memory means according to the present invention. As the contact ROM 34, electric memory means that is electrically rewritable is used appropriately. The contact ROM 34 according to this embodiment is configured by an EEPROM that is one type of semiconductor memory means. In a place, which is located in the other end portion of the bottom face in the longitudinal direction, facing a contact terminal 33 (see FIG. 2) that is disposed on the carriage 4 in a state installed to the carriage 4, a contact part 34a that is conductive to the contact terminal 33 is included.

In this contact ROM 34, various types of information on the ink cartridge 3 are recorded. For example, a model code that represents the model of the printer 1, a date code such as year, month, and date of manufacture, ink information (one type of liquid information), an installation date and time data that represents date and time of installation of the ink cartridge 3, and the like are recorded. In the ink information, a material code that represents the color of a coloring material such as pigment or dye and ink, coloring material density information, viscosity information, light irradiation amount information, and the like are included.

The ultraviolet irradiation device 12 is configured by arranging a plurality of semiconductor light emitting elements as light sources in a matrix shape on a support plate 11 that has a horizontal length corresponding to the width of the recording medium 6 of a maximum size that can be used by the printer 1. The installation face of the support plate 11 to which the semiconductor light emitting elements are installed faces the platen 5, and the support plate 11 is fixed to the casing of the printer 1 by using a bracket or the like that is not shown in the figure. In addition, the support plate 11 is disposed in a position slightly apart from the record head 2 to the downstream side in the sub scanning direction. This ultraviolet irradiating device 12 performs a curing process by irradiating an ultraviolet ray to the UV ink that lands in the recording medium 6. As an irradiation light source, a light emitting diode or a laser diode can be used. It is preferable that the irradiation light source emits light including wavelengths equal to or larger than 350 nm and equal to or smaller than 450 nm.

For irradiation of an ultraviolet ray, in the viewpoint of energy consumption, miniaturization, and a lamp life, an ultraviolet light emitting semiconductor element such as an ultraviolet LED or an ultraviolet light emitting semiconductor laser is preferable. When the ultraviolet LED is used, for example, it is preferable to combine an LED having a light emitting peak wavelength of 365 nm, an LED having a light emitting peak wavelength of 380 nm, and an LED having a light emitting peak wavelength of 395 nm. As other irradiation light source, there are a metal halide lamp, a xenon lamp, a carbon-arc lamp, a chemical lamp, a low-pressure mercury lamp, a high-pressure mercury lamp, and the like.

FIG. 2 is a block diagram showing the electrical configuration of the printer 1. The printer 1 according to this embodiment is configured mainly by a printer controller 35 and a print engine 36. In addition, in this printer 1, the contact terminal 33 that is conductive to the contact ROM 34 of the ink cartridge 3 is disposed.

The printer controller 35 includes an external interface (external I/F) 37 to which print data or the like is input from an external apparatus such as a host computer, a RAM 38 that records various types of data, a ROM 39 that records a control program or the like for various control processes, a non-volatile memory element 40 that is configured by an EEPROM, a flash ROM, or the like, a control unit 41 (one type of control means according to the present invention) that performs an overall control process for each unit in accordance with a control program that is recorded in the ROM 39, an oscillation circuit 42 that generates a clock signal, a driving signal generating circuit 43 that generates a driving signal to be supplied to the record head 2, and an internal interface (internal I/F) 45 for outputting dot pattern data, the driving signal, and the like that are acquired by expanding the print data for each dot.

The control unit 41 expands the print data transmitted from the external apparatus into dot pattern data corresponding to the dot pattern and transmits the dot pattern data to the record head 2. In the record head 2, ink is ejected based on the received dot pattern data. In addition, the control unit 41 reads out the ink information that is recorded in the contact ROM 34 of each ink cartridge 3 and controls correction of a voltage of a driving signal COM generated by the driving signal generating circuit 43, the amount of ultraviolet irradiation of the ultraviolet irradiating device 12, and the like based on the read-out ink information.

The driving signal generating circuit 43 serves as driving signal generating means that generates a driving signal for driving pressure generating means A of the record head 2. The driving signal COM that is generated by this driving signal generating circuit 43, for example, as shown in FIG. 4, is configured by arranging a group of a driving pulse DP1, a driving pulse DP2, a driving pulse DP3, and a microscopic vibration pulse DP4 that is used for microscopic-vibrating a meniscus at a non-recording time.

All the driving pulses DPI to DP3 of the driving signal COM have a same waveform shape. Then, by supplying only the driving pulse DP2 to the pressure generating means A (for example, a piezoelectric element, a heating element, or the like), a small dot is formed on the recording medium 6. Similarly, by supplying two driving pulses DP1 and DP3 to the pressure generating means A, a medium dot is formed. In addition, by supplying three driving pulses DP1, DP2, and DP3 to the pressure generating means A, a large dot is formed. Moreover, at a non-recording time, by supplying the microscopic vibration pulse DP4 to the pressure generating means A, the meniscus exposed to a nozzle opening is vibrated to the degree for which ink is not ejected from the nozzle opening.

By supplying the driving pulses DPI to DP3, the liquid amount of the discharged ink changes in accordance with the magnitude of the driving voltage Vh. Accordingly, it is preferable that the driving voltage Vh is set to an appropriate value in accordance with the type of the ink. The correction for the driving voltage Vh will be described later.

The print engine 36 is configured by the record head 2, the carriage moving mechanism 7, a paper feed mechanism 8, a linear encoder 10, and an ultraviolet irradiation device 12 (irradiation driving circuit). The record head 2 includes a shift register 46 in which the dot pattern data is set, a latch circuit 47 that latches the dot pattern data set in the shift register 46, a decoder 48 that generates pulse selection data by interpreting the dot pattern data from the latch circuit 47, a level shifter 49 that serves an a voltage amplifier, a switch circuit 50 that controls supply of the driving signal to the pressure generating means A, and the pressure generating means A.

The contact terminal 33 is configured so as to be electrically connected to the contact ROM 34 in a state in which the ink cartridge 3 is installed to the carriage 4. This contact terminal 33 is electrically connected to the control unit 41 of the printer controller 35. Thus, when the ink cartridge 3 is installed to the carriage 4, the control unit 41 can read out various types of information recorded in the contact ROM 34. Accordingly, the control unit 41 can detect the installation state of the ink cartridge 3 for the carriage 4 based on whether the recorded information of the contact ROM 34 can be read out. In addition, the control unit 41 can rewrite various types of information recorded in the contact ROM 34 in a state in which the ink cartridge 3 is installed.

In the printer 1 of the above-described configuration, when printing (recording operation) an image or the like for the recording medium 6 is started by the record head 2 or when the UV ink landing surface located on the recording medium 6 reaches an ultraviolet irradiation region for the ultraviolet irradiation device 12 after a recording operation is started, the light source of the ultraviolet irradiation device 12 is switched to a light emitting state. Then, the light emitting state of the light source is maintained until the UV ink landing surface located on the recording medium 6 passes through the ultraviolet irradiation region for the ultraviolet irradiation device 12. Accordingly, the UV ink that lands in the recording medium 6 can be cured in a speedy manner by irradiation of an ultraviolet ray.

However, there is a problem that the UV ink, compared to water-based ink, has a large change in viscosity according to elapse of a time after manufacture (generally, an increase in viscosity may easily occur) and has irregular viscosity for each color. Thus, for example, in a case where several ink cartridges 3 are replaced with new ones, irregularity in the viscosity for each color increases further. In addition, there are problems that the amount of ink varies, the consumed amounts of the ink cartridges 3 are different for each ink, and the like in a case where the ink is ejected from the nozzle opening by using a same driving signal COM for each color.

It is known that, for each color of ink, the minimum amount of ultraviolet irradiation (light irradiation amount light irradiation energy) needed for cure is different. The reason is that a coloring material has a property of absorbing an ultraviolet ray of a specific wavelength. When the light irradiation energy is excessively low, defective cure occurs. On the other hand, when the light irradiation energy is excessively high, durability after cure deteriorates (occurrence of cracks and breaks), and an effect of shrinkage of the recording medium (plastic film or the like) may occur.

Thus, in the printer 1 according to the present invention, by performing correction of the driving voltage of the driving signal COM and adjustment of the irradiation amount of an ultraviolet ray based on the ink information that is recorded in the contact ROM 34 of the ink cartridge 3, the above-described problems are solved. Hereinafter, this point will be described.

FIG. 5 is a diagram showing an example of the ink information that is recorded in the contact ROM 34 of each ink cartridge 3. In the ink information, viscosity information and light irradiation amount information are included. The viscosity information includes initial viscosity (mPa·s) at the time of manufacture of the UV ink and a viscosity changing rate (%/time (month)) according to elapse of time after manufacture of the UV ink. In addition, the light irradiation amount information is light irradiation energy (mJ/cm2) that is needed for curing a specific amount of the UV ink. The viscosity information may include viscosity after elapse of a predetermined period from the time of manufacture of the UV ink. Here, the time of manufacture of the UV ink represents a time point when ingredients composing the UV ink are mixed so as to be usable as the UV ink. In addition, information of content (pigment density in FIG. 5: weight % (Wt %)) of coloring material (pigment or the like), the type of monomer, and the type of initiator may be included therein.

Then, the controller 41 corrects the driving signal COM, which is generated by the driving signal generating circuit 43, based on the viscosity information relating to ink ejecting capability, the image quality of a recorded image, and the like of the ink information that is read out from the contact ROM 34 of the ink cartridge 3. In particular, based on the viscosity information, the driving voltage Vh of the driving pulses DP I to DP3 included in the driving signal COM, that is, the crest values (an electric potential difference between a highest electric potential and a lowest electric potential) of the driving pulses is corrected. Accordingly, the control unit 41 can adjust the pressure at the time of ink ejection by controlling the pressure generating means A.

In other words, the control unit 41 corrects the driving voltage Vh of the driving pulses DPI to DP3, which are included in the driving signal COM, in accordance with the initial viscosity. Here, in a case where ejection is performed by using a same driving pulse, as the viscosity of ink increases, the amount of ejected ink decreases. On the other hand, as the viscosity of the ink decreases, the amount of ejected ink increases. Accordingly, in a case where a reference value of the driving voltage Vh is adjusted to black ink, the driving voltage Vh is set to be lower than the reference value for ejecting yellow ink or cyan ink that has viscosity lower than that of the black ink. In other words, the driving voltage Vh may be set to be lower by the amount of decrease in the viscosity, and the driving voltage Vh may be set to be higher by the amount of increase in the viscosity. As a result, the amount of ejected ink and the flying speed of the ink can be uniform for each color regardless of the viscosity of the ink.

In addition, there is a case where the UV ink, compared to the water-based ink, has a high viscosity changing rate (%/time) with respect to the elapsed time from the time of manufacture. Thus, the control unit 41 corrects the driving voltage Vh based on the viscosity corresponding to the elapse of time from the time of manufacture. For example, the control unit 41 calculates an elapsed time based on the current date and time information and the manufacture date and time information that are read out from the contact ROM 34 of the ink cartridge 3, calculates the current viscosity based on the viscosity changing rate and the calculated elapsed time, and corrects the driving voltage Vh in accordance with the calculated current viscosity. In FIG. 5, in the example of black ink, the viscosity changing rate (in this case, the viscosity increasing rate) after one month from the time of manufacture is 12%. Thus, when one month elapses from the time of manufacture, the driving voltage Vh is changed (increased) by a predetermined amount corresponding to the current viscosity. In other words, in this case, the driving voltage Vh is increased compared to a case where the viscosity is second viscosity (for example, viscosity at the time of manufacture or calculated viscosity at the time of the previous correction) that is lower than the current viscosity (first viscosity). Similarly, for ink of a different color, correction is made such that the driving voltage Vh is changed (increased) in accordance with the current viscosity that is calculated based on the viscosity changing rate and the elapsed time. Accordingly, the pressure generating means A is controlled so as to increase the pressure at the time of ink ejection as the current viscosity increases. As a result, even when the viscosity increases, the variation (decrease) of the amount of ejected ink is suppressed. Accordingly, it is possible to maintain the characteristic of ink ejection to a designed characteristic regardless of the elapsed time from the time of manufacture.

In addition, the correction amount of the driving voltage Vh may be set arbitrary based on the result of a test for the relationship between the viscosity changing rate and the amount of ejection and the like. In addition, the viscosity of ink also changes in accordance with temperature. Thus, the temperature of the periphery of the head at the current time point may be reflected for calculating the current viscosity.

On the other hand, the control unit 41 adjusts the irradiation amount of the ultraviolet ray of the ultraviolet irradiating device 12 based on the light irradiation amount information, which relates to cure of the UV ink, of the ink information read out from the contact ROM 34 of the ink cartridge 3. The light irradiation amount information exemplified in FIG. 5 is light irradiation energy (mJ/cm2) needed for cure of the periphery of one droplet (for example, 5 pl) for a case where ink is ejected by using the above-described driving pulse. Accordingly, the control unit 41 adjusts the ultraviolet irradiation amount of the ultraviolet irradiating device 12, that is, the light amount (irradiation intensity), an irradiation time, or both the ultraviolet irradiation amount and the irradiation time based on the amount of ink ejection and light irradiation amount information. Accordingly, the UV ink that lands in the recording medium 6 can be effectively cured with a needed minimum light amount. As a result, it is possible to save energy. In addition, unevenness of the degree of cure of each ink can be suppressed. In addition, as in color printing, when an image or the like is recorded by simultaneously using ink (a plurality of types of light curable liquid) of each color, it is preferable to adjust the ultraviolet irradiation amount of the ultraviolet irradiating device 12 to ink (that is, ink that is the hardest to be cured) for which the light irradiation energy (mJ/cm2) needed for cure is the highest.

In addition, the light irradiation energy that is needed for cure changes in accordance with the current viscosity. In other words, as the current viscosity increases, the light irradiation energy needed for cure decreases. Accordingly, the control unit 41 adjusts the ultraviolet irradiation amount of the ultraviolet irradiating device 12 based on the current viscosity that is calculated from the viscosity changing rate and the elapsed time and the light irradiation amount information. In other words, the control unit 41 controls the ultraviolet irradiation amount of the ultraviolet irradiating device 12 to be decreased as the current viscosity increases. In other words, the ultraviolet irradiation amount is decreased compared to the case of the second viscosity that is lower than the current viscosity (first viscosity). Accordingly, the UV ink that lands in the recording medium 6 can be cured with higher efficiency. As a result, the energy can be saved further. In addition, the adjustment amount of ultraviolet irradiation amount on the basis of the current viscosity can be set arbitrary based on the result of a test for the relationship between the viscosity of the UV ink and the light irradiation energy needed for cure and the like.

As described above, by performing correction for the driving voltage Vh of the driving signal COM and adjustment of the ultraviolet irradiation amount of the ultraviolet irradiating device 12 based on the ink information that is recorded in the contact ROM 34 of the ink cartridge 3, the characteristics of the UV ink, that is, the initial viscosity and the viscosity increasing rate or the variation of the ultraviolet irradiation amount can be responded. Accordingly, the image quality at a time when an image or the like is recorded on the recording medium 6 by using the UV ink can be maintained to be optimal.

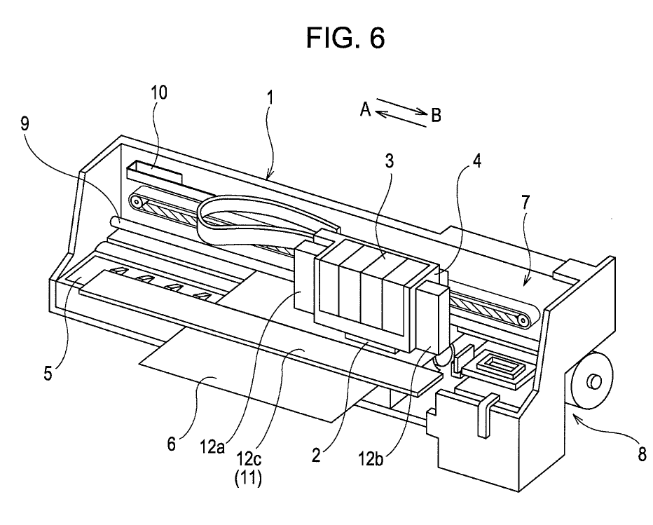

Next, another embodiment of the present invention will be described. FIG. 6 is a perspective view showing the configuration of a printer 1 according to a second embodiment. A difference between this embodiment and the first embodiment is the configuration of an ultraviolet irradiating device 12. The ultraviolet irradiating device 12 according to this embodiment is configured by one pair of preliminary-cure irradiation devices 12a and 12b (one type of preliminary-cure irradiation means according to the present invention) that are disposed on both sides of the carriage 4 in the main scanning direction and a main-cure irradiation device 12c (one type of main-cure irradiation means according to the present invention) that is disposed on the downstream side in the paper feed direction relative to the carriage 4.

The preliminary-cure irradiation devices are formed by a one-side preliminary-cure irradiation device 12a that is disposed on one side in the main scanning direction and the other-side preliminary-cure irradiation device 12b that is disposed on the other side in the main scanning direction. These preliminary-cure irradiation devices 12a and 12b preliminary cures UV ink to be preliminary fixed to the recording medium 6 by quickly irradiating an ultraviolet ray for the UV ink that is ejected from the nozzle opening of the record head 2 and lands in the recording medium 6. In addition, the amount of ultraviolet irradiation (light irradiation energy) of the preliminary-cure irradiation devices 1 2a and 1 2b is set such that not the entire ink droplets (one type of liquid droplets according to the present invention) are completely cured but only the surface of the ink droplets are cured in a film shape. Accordingly, for example, spread of ink on the recording medium 6 such as plastic that has a water-absorbing property lower than that of a paper sheet can be prevented. On the other hand, the main-cure irradiation device 12c has a same configuration as that of the ultraviolet irradiating device 12 according to the first embodiment. This main-cure irradiation device 12c performs a main curing process in which the UV ink is cured further to be completely fixed to the recording medium 6 by irradiating an ultraviolet ray for the UV ink that is preliminary cured (preliminary fixed) by the preliminary-cure irradiation devices 12a and 12b.

According to the printer 1 of the above-described configuration, an ultraviolet ray is irradiated for the UV ink that lands in the recording medium 6 by switching the light source of the one-side preliminary-cure irradiation device 12a to be in the light extinguishing state and switching the light source of the other-side preliminary-cure irradiation device 12b to be in the light emitting state at a time when the record head 2 moves forwardly (at a time of scanning in a direction denoted by arrow A in FIG. 1). On the other hand, when the record head 2 moves backward (when the record head scans in a direction denoted by arrow B in FIG. 1), the light source of the one-side preliminary-cure irradiation device 12a is switched to be in the light emitting state so as to irradiate an ultraviolet ray for the UV ink that lands in the recording medium 6, and the light source of the other-side preliminary-cure irradiation device 12b is switched to be in the light extinguishing state. Accordingly, the UV ink that lands in the recording medium 6 can be preliminary-cured in a speedy manner by irradiating the ultraviolet ray. In addition, when the landing surface of the UV ink located on the recording medium 6 reaches the ultraviolet irradiation region of the main-cure irradiation device 12c, the light source of the main-cure irradiation device 12c is switched to be in the light emitting state. Accordingly, the light source emits light with a predetermined intensity for a predetermined time until the landing surface of the UV ink on the recording medium 6 completely passes through the ultraviolet irradiation region of the main-cure irradiation device 12c. Accordingly, the main curing process can be performed by irradiating the ultraviolet ray of predetermined energy for the UV ink that lands in the recording medium 6.

Here, according to this embodiment, as the light irradiation amount information, light irradiation energy (preliminary-cure light irradiation energy) that is needed for the preliminary cure of the preliminary-cure irradiation devices 12a and 12b is recorded in the contact ROM 34 for each color of ink. In particular, minimum light irradiation energy and maximum light irradiation energy that are needed for preliminary cure are included therein. The control unit 41 sets the light irradiation energy (ultraviolet irradiation amount) of the preliminary-cure irradiation devices 12a and 12b to a maximum of the minimum light irradiation energy that is recorded as the light irradiation amount information. Accordingly, the UV ink that is the hardest to be cured can be preliminary-cured more assuredly. As a result, spread of the UV ink after landing in the recording medium 6 can be suppressed more assuredly. In addition, the control unit 41 sets the light irradiation energy of the preliminary-cure irradiation devices 12a and 12b sets to light irradiation energy corresponding to the UV ink that is the hardest to be cured within a range not exceeding the maximum of the light irradiation energy of ink on any side. Accordingly, while the UV ink that is the hardest to be cured is preliminary-cured more assuredly, occurrence of cracks and breaks due to unnecessary excessive irradiation of light can be prevented. In addition, the above-described embodiment may be combined to this embodiment.

However, the present invention is not limited to the above-described embodiments, and various changes in forms can be made therein based on claims.

In the above-described embodiments, although an example in which the driving voltage Vh of the driving pulses DP 1 to DP3 that are included in the driving signal COM is corrected based on the viscosity information has been shown, however, the invention is not limited thereto. For example, a configuration for correcting the median electric potential Vb of the driving pulses can be employed. In other words, for the pressure generating means A of a vertical-vibration type represented in the above-described embodiments, it may be switched to a correction process for increasing the driving voltage Vh so as to decrease the median electric potential Vb, and it may be switched to a correction process for decreasing the driving voltage Vh so as to increase the median electric potential Vb.

In addition, in the above-described embodiments, correction is performed based on the viscosity information of ink. However, in a case where the ink viscosity changing rate is small, the driving voltage may be corrected based on information of the density of the coloring material, the type of monomer, the type of the initiator, or the like.

Here, depending on the composition (for example, radical reactivity) of UV ink, the UV ink may not be easily cured due to influence of oxygen at the time of cure through light irradiation. In particular, the UV ink may be easily influenced by oxygen so as to deteriorate cure through light irradiation as the ink droplet of the UV ink that lands in the recording medium 6 decreases in size. Accordingly, as the viscosity information that is recorded in the contact ROM 34, oxygen-inhibition information that represents the degree of difficulty for curing the UV ink due to the influence of oxygen at the time of light irradiation may be included. Then, the control unit 41 adjusts the ultraviolet irradiation amount (light irradiation energy) of the ultraviolet irradiating device 12 in accordance with the size of the ink droplet of the UV ink ejected from the nozzle opening of the record head 2 and the oxygen-inhibition information. For example, the light irradiation energy for ink droplets of the small dot that is the minimum size to be ejected by the record head 2 is increased by the degree of oxygen inhibition of the UV ink (the light irradiation energy is increased to be higher than that recorded in the contact ROM 34, or the light irradiation energy is increased to be higher than that for ink droplets of other sizes). In other words, when the oxygen inhibition has a predetermined value (first inhibition), the light irradiation energy for the ink droplets of a small dot is increased, compared to a case where the oxygen inhibition has a lower value (second inhibition). The reason is that as the size of the ink droplet (liquid droplet) decreases, the ratio of the surface area to the weight of the ink droplet increases. Accordingly, as the size of the ink droplet decreases, the ink droplet can be easily influenced by oxygen in the air. As a result, the UV ink can be cured more assuredly regardless of the composition of the UV ink or the size of the ink droplet.

In addition, a configuration in which the size of ink droplets ejected from the record head 2 is changed based on the oxygen-inhibition information without changing the light irradiation energy may be used. In particular, the control unit 41 may be configured (for example, only a median dot and a large dot are used without using the small dot that is the minimum size or the weight of the ink droplet included in a dot is increased with a predetermined ratio) to increase the size of the ink droplets of the UV ink ejected from the record head 2 as the oxygen inhibition of the UV ink increases can be used. In this configuration, the influence of oxygen at the time of light irradiation is suppressed, and thereby the UV ink can be cured more assuredly.

In addition, the present invention may be applied to a liquid ejection apparatus other than the above-described printer as long as the liquid ejection apparatus has a configuration in which liquid is ejected by using pressure generating means. For example, the present invention may be applied to a display manufacturing apparatus, an electrode manufacturing apparatus, and a chip manufacturing apparatus.

The entire disclosure of Japanese Patent Application No. 2007-322969, filed Dec. 14, 2007 is incorporated by reference herein. And the entire disclosure of Japanese Patent Application No. 2008-298192, filed Nov. 21, 2008 is incorporated by reference herein.

1. A liquid ejection apparatus comprising:
a liquid ejecting head that can eject light-curable liquid collected in a liquid storage from a nozzle opening for an ejection target by operating a pressure generating unit by applying a driving signal;
a light irradiating unit that cures the light-curable liquid by irradiating light for the light-curable liquid that lands in the ejection target; and
a control unit that controls ejection of the liquid of the liquid ejecting head and irradiation of light of the light irradiating unit,
wherein a liquid storage having a memory unit that records liquid information including viscosity information and light irradiation amount information of the collected light-curable liquid is installed to the liquid ejection apparatus,
wherein the control unit reads out the liquid information that is recorded in the memory unit of the liquid storage and controls the pressure generating unit based on the viscosity information of the read-out liquid information, and adjusts a light irradiation amount of the light irradiating unit based on the light irradiation amount information of the read-out liquid information.

2. The liquid ejection apparatus according to claim 1,
wherein the viscosity information includes a viscosity changing rate of the light-curable liquid with respect to an elapsed time after the time of manufacture, and
wherein the control unit calculates current viscosity based on the viscosity changing rate and the elapsed time and controls the pressure generating unit in accordance with the calculated current viscosity.

3. The liquid ejection apparatus according to claim 2, wherein, for a case where the current viscosity is first viscosity, the control unit controls the pressure generating unit such that pressure at a time of liquid ejection is higher than that of a case where the current viscosity is second viscosity that is lower than the first viscosity.

4. The liquid ejection apparatus according to claim 3, wherein, for a case where the current viscosity is the first viscosity, the control unit sets the driving voltage to be higher than that of a case where the current viscosity is the second viscosity that is lower than the first viscosity.

5. The liquid ejection apparatus according to claim 1,
wherein the light irradiation amount information is information on light irradiation energy that is needed for curing the light-curable liquid, and
wherein the control unit adjusts the light irradiation energy of the light irradiating unit based on the current viscosity and the light irradiation amount information.

6. The liquid ejection apparatus according to claim 5, wherein, for a case where the current viscosity is first viscosity, the control unit controls the light irradiating unit such that the light irradiation energy is lower than that of a case where the current viscosity is second viscosity that is lower than the first viscosity.

7. The liquid ejection apparatus according to claim 5,
wherein the liquid ejecting head is configured to be able to eject a plurality of types of light-curable liquid,
wherein the light irradiation amount information is recorded in the memory unit for each type of the light-curable liquid, and
wherein the control unit sets light irradiation energy of the light irradiating unit to light irradiation energy corresponding to light-curable liquid that is the hardest to be cured.

8. The liquid ejection apparatus according to claim 1, wherein the light irradiating unit is configured by a preliminary-cure irradiation section that preliminary cures the light-curable liquid to a degree not for completely curing the light-curable liquid by irradiating light for the light-curable liquid that lands in the ejection target and a main-cure irradiation section that further cures the light-curable liquid by irradiating light for the light-curable liquid that is preliminary cured by the preliminary-cure irradiation section.

9. The liquid ejection apparatus according to claim 8, wherein the light irradiation amount information for each type of the light-curable liquid includes minimum light irradiation energy and maximum light irradiation energy that are needed for the preliminary cure, and
wherein the control unit sets the light irradiation energy of the preliminary-cure irradiation section to maximum light irradiation energy of the minimum light irradiation energy that is recorded in the memory unit as the light irradiation amount information.

10. The liquid ejection apparatus according to claim 9, wherein the control unit sets the light irradiation energy of the preliminary-cure irradiation section within a range not exceeding any of the maximum light irradiation energy that is recorded in the memory unit as the light irradiation amount information.

11. The liquid ejection apparatus according to claim 1,
wherein the viscosity information includes oxygen inhibition information that represents the difficulty of cure of the light-curable liquid due to the influence of oxygen at a time of light irradiation, and
wherein the control unit adjusts the light irradiation energy of the light irradiating unit in accordance with the size of a liquid droplet and the oxygen inhibition information of the light-curable liquid ejected from the nozzle opening.

12. The liquid ejection apparatus according to claim 11, wherein, for a case where the oxygen inhibition is first inhibition, the control unit sets the light irradiation energy for a smallest liquid droplet to be higher than that of a case where the oxygen inhibition is second inhibition that is lower than the first inhibition.

13. The liquid ejection apparatus according to claim 1,
wherein the viscosity information includes oxygen inhibition information that represents the difficulty of cure of the light-curable liquid due to the influence of oxygen at a time of light irradiation, and
wherein the control unit changes the size of the liquid droplet ejected from the liquid ejecting head based on the oxygen inhibition information.

14. The liquid ejection apparatus according to claim 13, wherein the control unit increases the size of the ink droplet ejected from the liquid ejecting head as the oxygen inhibition increases.

15. A liquid storage that collects light-curable liquid and is installed to a liquid ejection apparatus, the liquid storage comprising a memory unit that records liquid information of the collected light-curable liquid, wherein the liquid information includes viscosity information and light irradiation amount information.

16. A control method of a liquid ejection apparatus including:
a liquid ejecting head that can eject light-curable liquid collected in a liquid storage for an ejection target by operating a pressure generating unit by applying a driving signal;
a light irradiating unit that cures the light-curable liquid by irradiating light for the light-curable liquid that lands in the ejection target; and
a control unit that controls ejection of the liquid of the liquid ejecting head and irradiation of light of the light irradiating unit,
wherein a liquid storage having a memory unit that records liquid information including viscosity information and light irradiation amount information of the collected light-curable liquid is installed to the liquid ejection apparatus,
the control method comprising:
reading the liquid information that is recorded in the memory unit of the liquid storage;
controlling the pressure generating unit based on coloring material density information and viscosity information of the read-out liquid information; and
adjusting the irradiation amount of light of the light irradiating unit based on the light irradiation amount information of the read-out liquid information.
